(19) United States
(12) Patent Application Publication
(10) Pub. No.: US 2011/0247013 A1
(43) Pub. Date: Oct. 6, 2011

(54) Method for Communicating Between Applications on an External Device and Vehicle Systems

(75) Inventors: Ross FELLER, Palo Alto, CA (US); Alfred C. TOM, San Francisco, CA (US); Byron T. SHAW, Portola Valley, CA (US)

(73) Assignee: GM GLOBAL TECHNOLOGY OPERATIONS, INC., Detroit, MI (US)

(21) Appl. No.: 12/752,437

(22) Filed: Apr. 1, 2010

(51) Int. Cl. G06F 13/00; G06F 9/46; G06F 3/14; G06F 15/16

(52) U.S. Cl. 719/320; 717/178; 726/2; 715/864; 719/320; 709/219

(57) ABSTRACT

A is provided method for communicating between software applications on a portable device and a software-controlled vehicle system of a vehicle. The portable device is linked to the software-controlled vehicle system. The portable device includes a host software application and slave software applications. The host software application is capable of enabling slave software applications stored on the portable device through the software-controlled vehicle system. The host software application is enabled in response to establishing a communication link from the software-controlled vehicle system to the portable device. An authorized slave software application of the portable device is manually selected utilizing a vehicle human machine interface of the vehicle. The selected slave software application is launched via the host software application invoking a launch request command to the selected slave software application. An operating system of the portable device executes control of the selected slave software application via the vehicle human machine interface.

### BACKGROUND OF INVENTION

An embodiment relates generally to external device integration within a vehicle.

Vehicles can include various software-based applications that provide phone network capabilities, navigation, web browsing, etc. Such applications, if available from the manufacturer, can be added to a vehicle as an option which typically comes as a significant added cost. Each respective application added to the vehicle typically has a designated interface that is specific for interacting with the user of the vehicle. Interface devices that may combine the input controls so that a single interface device is used to control more than one application is a possibility; however, if the application is not added at the time when vehicle is manufactured, the necessary communication links, input controls, and operating system required to operate the application is not installed and typically is not feasible to add thereafter.

### SUMMARY OF INVENTION

An advantage of an embodiment is the use of a portable device having a plurality of authorized software applications where each authorized software application is capable of being launched on the portable device through a vehicle-based interface system. A host software application stored on the portable device functions as a host for initiating communication and providing authentication between the vehicle interface system and the portable device. The host software application presents a list of authorized software applications via a vehicle human machine interface to a user. The user selects a respective software application from the list using the human machine interface and the selection is executed by the portable device. The selected application content is output to the user via a vehicle accessory device of the vehicle. The launching of the software applications stored on the portable device allows a user to forego purchasing optional and costly software applications on the vehicle at the time of manufacture. Moreover, the applications can be added or deleted at the discretion of the user.

An embodiment contemplates a method for communicating between software applications on a portable device and a software-controlled vehicle system of a vehicle. The portable device is linked to the software-controlled vehicle system. The portable device includes a host software application and slave software applications. The host software application is capable of enabling slave software applications stored on the portable device through the software-controlled vehicle system. The host software application is enabled in response to establishing a communication link from the software-controlled vehicle system to the portable device. An authorized slave software application of the portable device is manually selected utilizing a vehicle human machine interface of the vehicle. The selected slave software application is launched via the host software application invoking a launch request command to the selected slave software application. An operating system of the portable device executes control of the selected slave software application via the vehicle human machine interface.

An embodiment contemplates a portable device-to-vehicle interface communication system. A portable device is provided and capable of running a host software application and a plurality of slave software applications. The host software application is capable of enabling slave software applications stored on the portable device via a vehicle. A vehicle interface system communicates with the portable device. The vehicle interface system includes at least one human machine interface device for receiving input commands from a user for selecting and controlling the plurality of slave software applications on the portable device. The host software application is enabled in response to establishing a communication link from the vehicle interface system to the portable device. A challenge-response authentication is initiated between the vehicle interface system and the host software application. The host software application presents a list of authorized slave software applications to a user. A respective slave software application is manually selected utilizing the at least one human machine interface device. The selected slave software application is launched via the host software application invoking a launch request command to the selected slave software application. An operating system of the portable device executes control of the selected slave software application via the vehicle human machine interface.

### BRIEF DESCRIPTION OF DRAWINGS

FIG. 1 is a block diagram of a portable device-to-vehicle interface communication system.

FIG. 2 is a flowchart for a method for enabling a plurality of software application stored on a portable device through a vehicle

### DETAILED DESCRIPTION

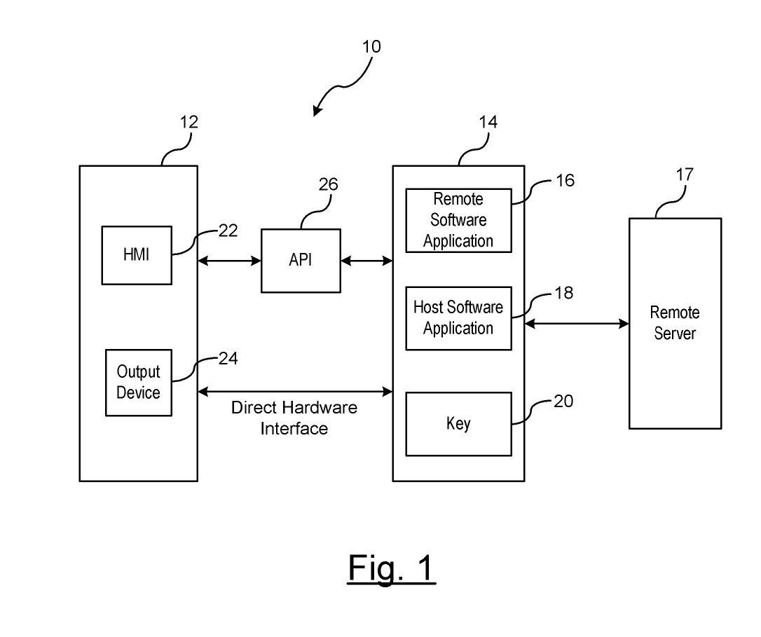

There is shown in FIG. 1 a block diagram of a portable device-to-vehicle interface communication system shown generally at 10. The system 10 includes a vehicle interface system 12 that communicates with a portable device 14.

The portable device 14 is carried by a user of the vehicle and is capable of storing and executing a plurality of software applications 16 (hereinafter referred to as slave software applications). Examples of a portable device 14 include, but are not limited to, smartphones, netbooks, e-reader, personal digital assistant (PDA) and any other device capable of running the plurality of software applications. The plurality of slave software applications 16 includes, but is not limited to, music, DVD, phone, navigation, weather, email and a web browser. Applications may be added or deleted from the portable device 14 at the user's discretion. Applications added to the portable device are accomplished by linking to a remote server 17 and downloading the application. Alternatively, a removable storage device may also be used to download the application. The applications obtained from the remote server 17 may be a pay-for-download or a free-download. It should be understood that all applications used with the system 10 are approved for usage by a second party entity. This minimizes the risk of utilizing unauthorized software that may be corrupt or malicious software or may be software that is unsafe to use while driving.

The portable device 14 further includes a host software application 18. The host software application 18 provides functionality such as authenticating the portable device, presenting a list of available slave software applications to a user, and enabling a selected slave software application. The host software application 18 also obtains a key 20 from the vehicle for authenticating slave software applications 16 to the vehicle interface system 12. The vehicle may either contain a pre-existing key or the vehicle may include key generating hardware (such as a trusted module) and software for producing the key that is provided to the portable device 14 to store. The key 20 may be a digital key, a credential key, or similar. The key 20 when provided to a selected slave software application 16 by the host software application 22 provides credentials for verification to the vehicle interface system 12 that the selected slave software application is an authorized application. If an application does not have the associated key, the vehicle interface system 12 determines the application is not an approved software application and will not allow the application to interface with the vehicle.

The vehicle-based interface system 12 includes at least one human machine interface (HMI) device 22. Preferably, the HMI device 22 has dual functionality that includes accepting a user's manual input and/or presenting application content to the user. An example of an HMI that includes dual functionality is a navigation device. The navigation device has dedicated buttons or a touch screen for accepting the user's selection. The navigation device further includes a display screen that can be used to display application content. Another example of a device having dual functionality is a radio system. Radio control buttons/knobs can be used by the user for making input selections and the radio display may be used for presenting the application content to the user.

Alternatively, two separate devices may be used for input selection and output selection, respectively. For example, a respective HMI device may be used for receiving a user input selection, such as a switch disposed on the steering wheel. A second respective device 24 used to present application content to the user may include a message display screen such as those used to display vehicle speed, fuel economy, odometer readings, etc. The portable device 14 may also be used to present application content to the user. Moreover, text-to-speech functionality may also be provided by the vehicle interface system 12 or the portable device 14 to output audio to the user in the vehicle. In addition, the vehicle could also provide a speech recognition system for entering text into an application on the portable device. The speech recognition system would be an alternative for a control input switch, touch screen, keyboard or similar.

The system 10 further includes an application programming interface (API) 26 that is a software program used to enable interaction between the portable device 14 and the vehicle interface system 12. That is, the API 26 allows the HMI 22 of the vehicle interface system 12 to be configured for data communication with the portable device 14. The API 26 utilizes applications, instructions, libraries and operating systems to determine the specifications for routines, data structures, and protocols used to communicate between portable device 14 and the vehicle interface system 12. The API 26 defines how the vehicle interface system 12 and portable device 14 communicate to authenticate, configure the HMI 22, exchange content, and exchange control information. It should be understood that the API 26 may include a complete interface, a single function interface, or a plurality of interfaces. The API may define just the communication protocol, or extend to cover programming language syntax and software function calls.

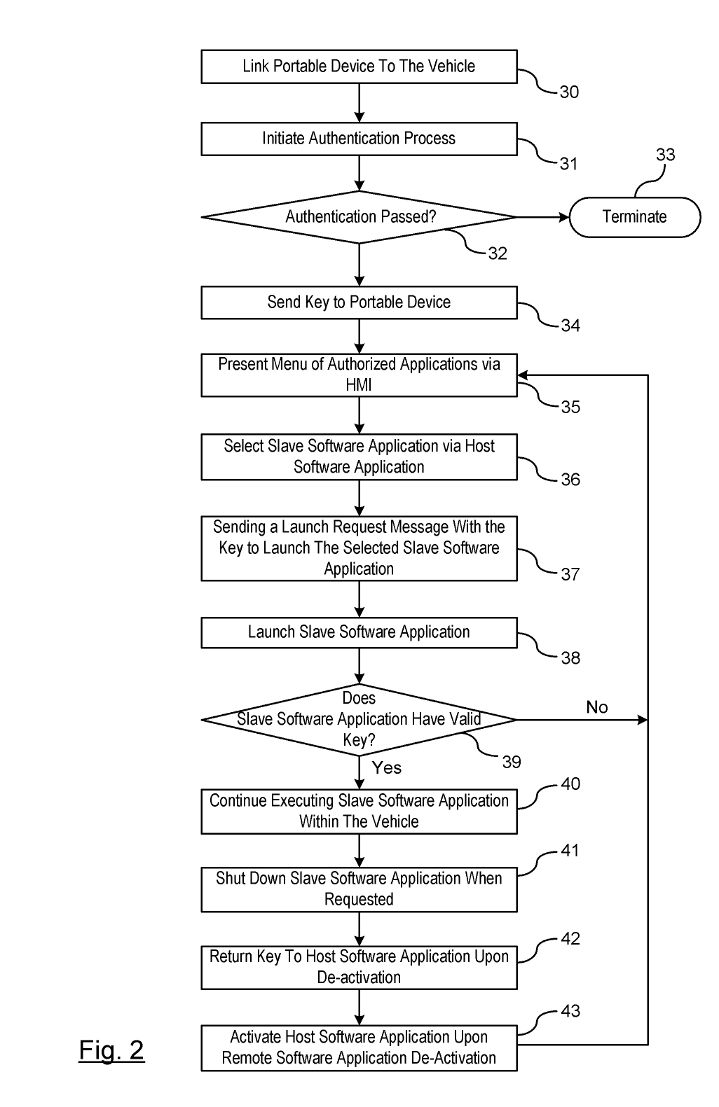

FIG. 2 illustrates a flowchart for enabling a selected slave software application stored on the portable device through the vehicle interface system of a vehicle.

In block 30, the portable device is linked to the vehicle interface system of the vehicle. The communication link may be a wireless communication medium or a wireline communication medium. The portable device 14 may utilize a universal serial bus (USB) specification for connection between vehicle and the portable device whereas switches on the vehicle HMI may utilize set voltage outputs for communicating signals to the vehicle HMI. For example, steering control switches may be direct voltage inputs of 5 volts, whereas the portable device may utilize the USB communication standard. Since a USB-based device transfers data under various bandwidths at various voltages, the two devices are not directly compatible with one another. As a result, the HMI is used to translate signals between the respective devices relating to the input commands by the user. It should be understood that one or more processors either within the various HMI devices or remote processors having shared responsibilities process the respective signals for authenticating challenges, translating signals between the HMI and USB, and perform other processing operations. In addition, the portable communication device may also utilize a direct hardware video out signal to project the graphical contents of the portable device's screen, or any other graphical content, onto a vehicle screen. Video signals such as HDMI and composite video may be used.

In block 31, the vehicle interface system of the vehicle initiates an authentication process with the host software application of the portable device. This may be performed by a challenge-response authentication process or any other security process including communication between the host software application and the remote server for verifying authentication.

In block 32, a determination is made whether the authentication is valid. If the authentication process is unsuccessful, the communication connection to portable device is terminated in block 33. If the authentication process is successful, then the routine proceeds to block 34. The security check described in blocks 31 and 32 may be repeated periodically to verify authenticity. If at any time the communication between the two devices cannot be authenticated, then the communication connection is terminated. For added security, the host software application can authenticate the identification of the vehicle interface system, if required. For example, the host application may only be able to interface with certain vehicles made by the same manufacturer.

In block 34, the vehicle interface system of the vehicle supplies a digital key or similar to the host software application of the portable device over the established communication link. The key is used to authenticate a slave software application when selected. Slave software applications are prevented from functioning through the vehicle interface system unless the key is presented by selected software application when the software application is challenged by the vehicle. It should also be understood that the host software application also utilizes the digital key as a tracking device for determining which slave software application is currently enabled. Although the user may have more than one slave software application on the portable device opened, only one application may be enabled for interaction with the vehicle HMI at any one time. Therefore, the key is used to identify which slave software application is authorized for interfacing with the vehicle interface system.

In block 35, the host software application of the portable device presents a list of all the available slave software applications authorized for execution through HMI of the vehicle interface system. Some slave software applications may be restricted from use/functionality at a current time due to the state of the vehicle. For example, applications that are considered unsafe for execution while driving above certain speeds are restricted from being activated. Therefore, when in a restricted state, certain applications or all application functionality will be disabled. Note that vehicle information such as vehicle speed, location, and other information of use to portable device applications may be sent to from the vehicle to the portable device through the API.

As described earlier, the list of applications may be modified by the user. The user can add/remove applications that are supported in the vehicle by customizing the host software application of the portable device. Customization of the list of slave software applications can be accomplished through the vehicle interface system of the vehicle, through the host software application of the portable device, or through a website via a remote server. Authorized slave software applications which are compatible for use in a vehicle and compatible with the host software application of the portable device may be determined by a governing second party. This may be done for propriety reasons, or to keep applications from operating that are unsuitable for use in the vehicle while driving, or to prevent unknown or malicious software applications from operating on the vehicle interface system of the vehicle.

The host software application may periodically link to a remote server to verify the authorized slave software applications that the user has chosen and/or paid for is on the list.

In block 36, in response to the list of slave software applications being presented by the HMI, the user selects a desired slave software application to launch. The HMI used to select from the list of slave software applications may include, but is not limited to, switches on the steering wheel, inputs for navigation unit (e.g., hard buttons or touch screen), radio control switches, message center display switches, and speech recognition. The interface between the host software application and the HMI is controlled through the API. Moreover, user is prevented from selecting or enabling applications that are not authorized as part of the list provided by the host software application.

In block 37, the host software application invokes a launch request command to the respective slave software application along with the key. A remote procedure call (RPC) may be used to send the launch request command and key from the host software application to the selected slave software application. The RPC initiated by the host software application is an order to execute a launch procedure. The slave software application may acknowledge the launch request by responding to the host software application and continue along with its process of launch. When the response is received, the host software application may be de-activated to allow the slave software application to interface with the vehicle interface system of the vehicle. The operating system of the portable device manages and coordinates the activities, execution, and sharing of the resources of the host software application and the slave software applications of the portable device. Some operating systems do not allow multiple software application to run simultaneously, in which case de-activation may consist of closing the application. In other operating systems that allow multi-tasking de-activation may mean the host application goes into a background state.

In some systems, the host software application may notify the vehicle that a slave application is about to launch. This may prompt the vehicle into sending an authentication challenge to the slave software application just when it launches.

In block 38, the portable device launches the slave software application in response to the launch response message from the host software application.

In block 39, the vehicle interface system of the vehicle determines if the slave software application that is being launched has the valid key. The determination is made to verify that an approved application is being launched. If the determination is made that the slave software application does not have the valid key, the slave software application is not allowed access to the vehicle interface and a return is made to block 34. A notice may be provided to the user informing the user of an unauthorized application attempting to launch. The user will be automatically redirected or the user will be required to acknowledge the unauthorized software attempt to launch and redirect the routine to the home page (e.g., display of authorized slave software applications). The method of this return may vary depending on the portable device system. In some cases the vehicle may then launch the host application via the API, bringing it to the forefront for the user to manipulate. If the determination is made that the slave software application does have the valid key, the routine proceeds to block 39.

The vehicle based interface system of the vehicle can at anytime during the activation of the slave software application request re-verification of the key. This is provided for added security such that the current application is not interrupted by a malicious application seeking to disrupt or corrupt the vehicle interface system.

In block 40, the vehicle interface system continues the process of running the slave software application in response to a valid authentication key. The HMI device receives inputs from the user of the vehicle for making selections for controlling the output of the slave software application. The operating system of the portable device interacts with the vehicle interface device of the vehicle for receiving requests and outputting responses or application content.

Output devices such as vehicle accessory devices are used to output the application content to the user of the vehicle. The accessory devices may include an HMI-based device or may include a device that is solely used to output application content such as screens and speakers. The output device re-produces the application content run on the portable device through the vehicle. Depending on the application content being reproduced, the appropriate accessory device is selected which serves the interface purpose. For example, if it is required that interaction with the user is required, then a HMI is used that will present inputs to the user and accept selections/commands from the user. Alternatively, the accessory device may require only that the device be a reproduction device when no response from the user is required (e.g., speakers for music playback). In summary, the vehicle accessory devices may include devices that can receive inputs and produce outputs, receive only inputs, or produce only outputs.

In block 41, the user selects to shut down the current selected application using an HMI of the vehicle or requests a home screen (i.e., host software application). It should also be understood that any input by the user to re-activate another application by way of the vehicle interface system or the portable device, or disconnect communication between the portable device and the vehicle interface system will be interpreted as a request by the user to de-activate the current selected application.

In block 42, the digital key may be transferred back to host software application from the previously selected slave software application upon the slave software application de-activating or notifying the vehicle interface system that it is de-activating. Transfer of the digital key to the host software application logs-in the key so that the host software application is able to keep track of the location of the digital key. The host software application may also authenticate itself to the vehicle to obtain a newly generated key. Therefore, the host application assures that the key that is provided to a slave software application is the authorized key. As a result, the host software application maintains the updated key so that the next slave software application selected will have the valid key to launch.

In block 43, the host software application is re-activated in response to the de-activation of the previously selected slave software application. The host software application controls the host state of the portable device by interfacing with the vehicle interface system when a slave software application is not running. A return is made to block 34 for presenting the user with the list of authorized applications via the HMI. If at anytime, the communication is lost between the portable device and the vehicle interface system, both interfaces will re-initialize and the routine will return to block 30 and await a confirmation of a communication link between the portable device and the vehicle interface system.

While certain embodiments of the present invention have been described in detail, those familiar with the art to which this invention relates will recognize various alternative designs and embodiments for practicing the invention as defined by the following claims.

What is claimed is:

1. A method for communicating between software applications on a portable device and a software-controlled vehicle system of a vehicle, the method comprising the steps of:
linking the portable device to the software-controlled vehicle system, the portable device including a host software application and slave software applications, the host software application capable of enabling slave software applications stored on the portable device through the software-controlled vehicle system;
enabling the host software application in response to establishing a communication link from the software-controlled vehicle system to the portable device;
manually selecting an authorized slave software application of the portable device utilizing a vehicle human machine interface of the vehicle; and
launching the selected slave software application via the host software application invoking a launch request command to the selected slave software application, and wherein an operating system of the portable device executes control of the selected slave software application via the vehicle human machine interface.

2. The method of claim 1 further comprising the step of initiating a challenge-response authentication between the software-controlled vehicle system and the host software application in response to linking the portable device to the software-controlled vehicle system.

3. The method of claim 2 further comprising the step of supplying a key to the portable device from the software-controlled vehicle system in response to authenticating the host software application, wherein the key is included in the launch request command, the key being used to authenticate the selected slave software application to the software-controlled vehicle system.

4. The method of claim 3 wherein the software-controlled vehicle system periodically re-verifies authentication of the host software application, wherein a new key is provided to the portable device from the software vehicle system after a successful authentication.

5. The method of claim 3 wherein the software-controlled vehicle system periodically re-verifies authentication of the enabled selected slave software application, wherein authentication is re-verified in response to the enabled selected slave software application presenting the key to the software-controlled vehicle system.

6. The method of claim 3 further comprising the step of transmitting a list of authorized slave software applications from the host software application to a vehicle human machine interface of the system to present to a user.

7. The method of claim 6 wherein the portable device is used to modify the list of slave software applications.

8. The method of claim 6 wherein the software-controlled vehicle system is used to modify the list of slave software applications.

9. The method of claim 1 wherein a remote procedure call is used to send the launch request command and key from the host software application to the selected slave software application.

10. The method of claim 1 wherein the host software application becomes inactive when the selected slave software application is enabled.

11. The method of claim 1 wherein the selected slave software application messages the host software application to re-activate upon disabling the selected slave software application.

12. The method of claim 1 wherein content output from the enabled slave software application is reproduced through a vehicle-based accessory device.

13. The method of claim 12 wherein the vehicle-based accessory device includes the vehicle human machine interface.

14. The method of claim 1 wherein content output from the enabled slave software application is reproduced through the portable device.

15. The method of claim 1 wherein content output from the enabled slave software application is reproduced through a text-to-speech device.

16. The method of claim 1 wherein the portable device links to a remote server for downloading additional slave software applications.

17. A portable device-to-vehicle interface communication system comprising:
a portable device capable of running a host software application and a plurality of slave software applications, the host software application capable of enabling slave software applications stored on the portable device via a vehicle; and
a vehicle interface system for communicating with the portable device, the vehicle interface system including at least one human machine interface device for receiving input commands from a user for selecting and controlling the plurality of slave software applications on the portable device;
wherein the host software application is enabled in response to establishing a communication link from the vehicle interface system to the portable device, wherein a challenge-response authentication is initiated between the vehicle interface system and the host software application, wherein the host software application presents a list of authorized slave software applications to a user, wherein a respective slave software application is manually selected utilizing the at least one human machine interface device, wherein the selected slave software application is launched via the host software application invoking a launch request command to the selected slave software application, and wherein an operating system of the portable device executes control of the selected slave software application via the vehicle human machine interface.

18. The system of claim 17 wherein the vehicle interface system supplies a key to the host software application in response to authenticating the host software application.

19. The system of claim 18 wherein the key is included in the launch request command.

20. The system of claim 17 wherein the key is used to authenticate the selected slave software application to the vehicle interface system.

21. The system of claim 17 further including a remote server, wherein the list of authorized slave software applications is updated by linking the portable device to the remote server.

22. The method of claim 21 wherein a remote server-based application is used to modify the list of slave software applications.

23. The system of claim 17 wherein the at least one human machine interface device for receiving input commands includes a steering wheel input actuation switch.

24. The system of claim 17 wherein the at least one human machine interface device for receiving input commands includes a touch screen input control device.

25. The system of claim 17 wherein the at least one human machine interface device for receiving input commands includes a vehicle messaging center.

26. The system of claim 17 wherein the at least one human machine interface device for receiving input commands includes a speech recognition system.

27. The system of claim 17 further comprising an output device for reproducing application content from the enabled slave software application, wherein the output device includes a vehicle-based accessory device.

28. The system of claim 17 wherein the vehicle-based accessory device includes the at least one vehicle human machine interface.

29. The system of claim 17 further comprising an output device for reproducing application content from the enabled slave software application, wherein the output device includes a text-to-speech device.

30. The system of claim 17 wherein the list of authorized slave software applications presented by the host software application to a user is presented via a respective vehicle human machine interface device.

31. The system of claim 17 wherein the portable device utilizes a direct hardware video out signal to project graphical content onto the vehicle HMI screen.
